(19) United States
(12) Patent Application Publication
(10) Pub. No.: US 2010/0318323 A1
(43) Pub. Date: Dec. 16, 2010

(54) MULTI-CHANNEL TRAINING SYSTEM AND METHOD

(76) Inventor: JAY JUDD WOMMACK, Texarkana, TX (US)

Correspondence Address: W. EDWARD RAMAGE, COMMERCE CENTER SUITE 1000, 211 COMMERCE ST, NASHVILLE, TN, 37201, US

(21) Appl. No.: 12/776,992

(22) Filed: May 10, 2010

Related U.S. Application Data
(60) Provisional application No. 61/176,718, filed on May 8, 2009.

(51) Int. Cl. G21C 17/00

(52) U.S. Cl. 702/182

(57) ABSTRACT

A system for training employees anywhere, anytime, using the Internet or a similar network using a multi-channel teaching method. The system ensures that employees view and understand important company policies, and can be used to implement important training such as sexual harassment and diversity training campaigns. The organizational information and training can be regular and ongoing. The system further may provide complete third-party documentation of the program's success in a company. The system also may empower companies to transfer special knowledge across the enterprise that was once limited to certain sectors by geographic or physical constraints. The system possesses the ability to distribute and disperse mass volumes of information in a way easily absorbed through video, the power to ensure clarity through audio instruction, and the capacity to stress critical information or high points through PowerPoint (or similar) slide presentations. In addition, modules may be repeated, allowing users the opportunity to reinforce their retention. The system also may incorporate testing to ensure that the user's total attention and interest is kept throughout the presentation. Audiences must pay attention to pass the tests at the end of each section. The shortness of the presentations and the multi-channel method further help to keep the user's interest.

This application claims benefit of and priority to U.S. Provisional Application No. 61/176,718, filed May 8, 2009, by Jay Wommack, and is entitled to that filing date for priority. The specification, figures and complete disclosure of U.S. Provisional Application No. 61/176,718 are incorporated herein by specific reference for all purposes.

### FIELD OF INVENTION

The present invention generally relates to a system and method for employee training and education.

### BACKGROUND OF THE INVENTION

Across every industry, there are companies struggling to survive in a turbid and unpredictable economic environment. Many organizations are seeking to improve their situation through education. Internal training programs and proprietary university systems are an increasingly common method of augmenting efficiency and remaining competitive. Many companies protect themselves through documentation and compliance with guidelines created by industry associations in an attempt to reduce corporate liability and exposure. Still other companies struggle to connect with their employees and to maintain their core values and top-to-bottom communication network through massive and expensive infrastructure systems.

Accordingly, what is needed is a virtual training, presentation and tracking system to provide training modules, including audio-visual training modules, to employees with a real-time reporting system.

### SUMMARY OF INVENTION

In one exemplary embodiment, the present invention allows companies to train their employees anywhere, anytime, using the Internet or a similar network. The system ensures that employees view and understand important company policies, and can be used to implement important training such as sexual harassment and diversity training campaigns. The organizational information and training can be regular and ongoing. The system further may provide complete third-party documentation of the program's success in a company. The system also may empower companies to transfer special knowledge across the enterprise that was once limited to certain sectors by geographic or physical constraints.

In one embodiment, the system combines simplicity and effectiveness through a multi-channel teaching method, which overcomes many of the problems associated with traditional teaching methods. The system possesses the ability to distribute and disperse mass volumes of information in a way easily absorbed through video, the power to ensure clarity through audio instruction, and the capacity to stress critical information or high points through PowerPoint (or similar) slide presentations. In addition, modules may be repeated, allowing users the opportunity to reinforce their retention. The system also may incorporate testing to ensure that the user's total attention and interest is kept throughout the presentation. Audiences must pay attention to pass the tests at the end of each section. The shortness of the presentations and the multi-channel method further help to keep the user's interest.

### DESCRIPTION OF THE DRAWINGS

FIG. 1 is a diagram showing a web site map of an exemplary embodiment of the present invention.

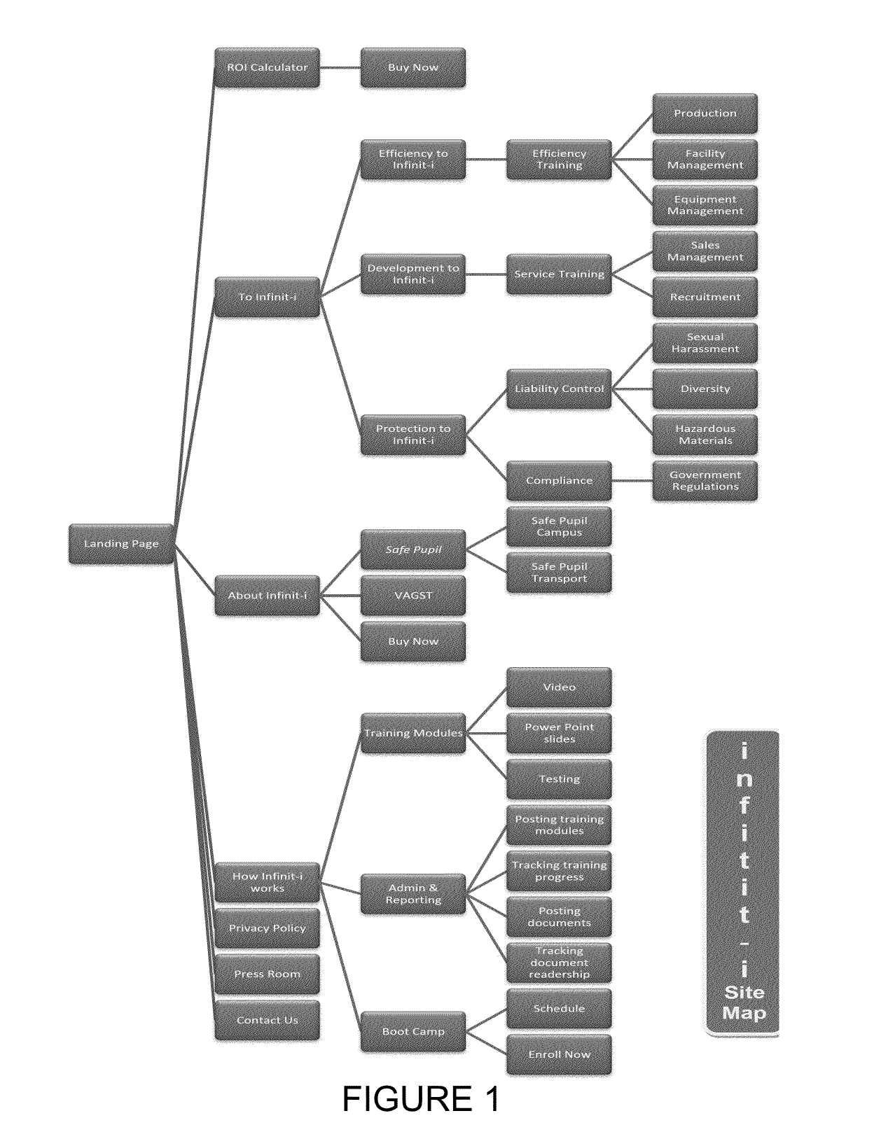

FIG. 2 is an example of a customized portal for a Web-based version of a system in accordance with an exemplary embodiment of the present invention.

FIG. 3 is an example of a log-in screen.

FIG. 4 is an example of a training module screen.

FIG. 5 is an example of testing screen.

FIG. 6 is an example of an Administrator Control Panel.

FIG. 7 is an example of a user editing screen.

FIG. 8 is an example of a reporting screen.

### DETAILED DESCRIPTION OF EXEMPLARY EMBODIMENTS

In one exemplary embodiment, the present invention allows companies to train their employees anywhere, anytime, using the Internet or a similar network. The system ensures that employees view and understand important company policies, and can be used to implement important training such as sexual harassment and diversity training campaigns. The organizational information and training can be regular and ongoing. The system further may provide complete third-party documentation of the program's success in a company. The system also may empower companies to transfer special knowledge across the enterprise that was once limited to certain sectors by geographic or physical constraints.

In one embodiment, the system combines simplicity and effectiveness through a multi-channel teaching method, which overcomes many of the problems associated with traditional teaching methods. The system possesses the ability to distribute and disperse mass volumes of information in a way easily absorbed through video, the power to ensure clarity through audio instruction, and the capacity to stress critical information or high points through PowerPoint (or similar) slide presentations. In addition, modules may be repeated, allowing users the opportunity to reinforce their retention. The system also may incorporate testing to ensure that the user's total attention and interest is kept throughout the presentation. Audiences must pay attention to pass the tests at the end of each section. The shortness of the presentations and the multi-channel method further help to keep the user's interest.

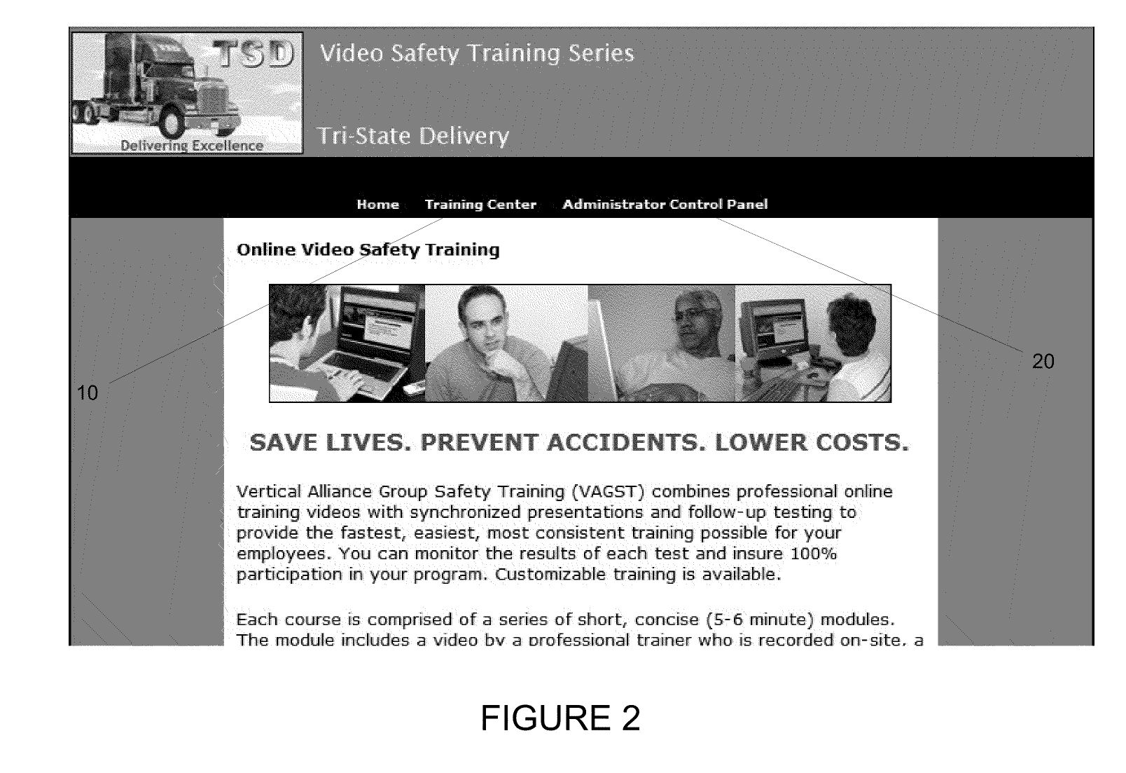

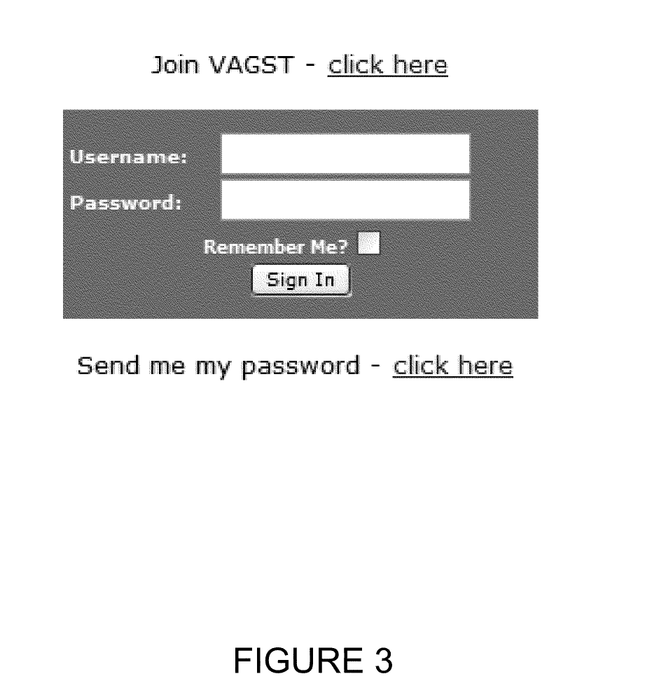

In one embodiment, the system comprises a User component and an Administrative component. FIG. 2 shows an exemplary embodiment of a customized portal for a Web-based version of the system. The portal is a specialized website for a particular company. The viewer can click on “Training Center” (or similar phrase, icon, or button) 10 to enter the User component, or “Administrator Control Panel” (or similar phrase, icon, or button) 20 to enter the Administrative component. In either case, the viewer is prompted to log in using a password (see FIG. 3).

In the Training Center, users view and complete training modules in a virtual classroom. The user is provided a list of training modules from which to choose. The list of possible modules may vary based on the user's name. A particular user may be provided only one choice, or multiple choices. Specific modules of training are assigned to distinct user groups, ensuring that only relevant training or communication is delivered. In one embodiment, a particular module may be started for the user immediately after log-in. Training modules may be short, delivered in high quality video and audio synched with PowerPoint slides.

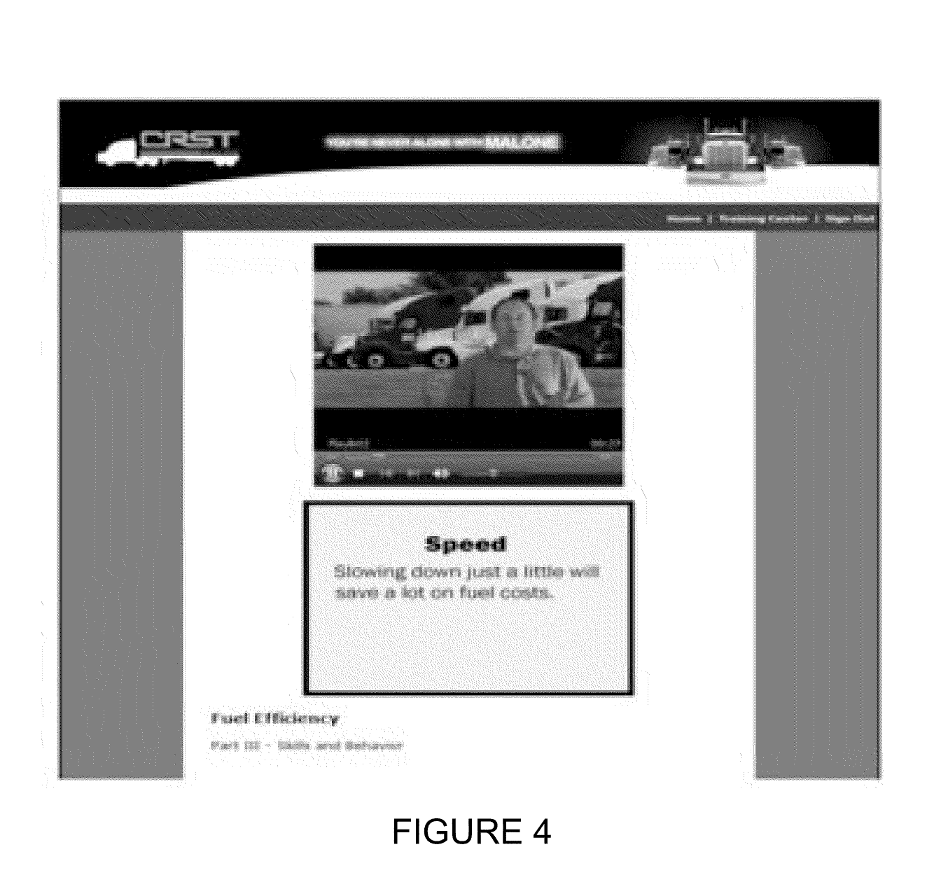

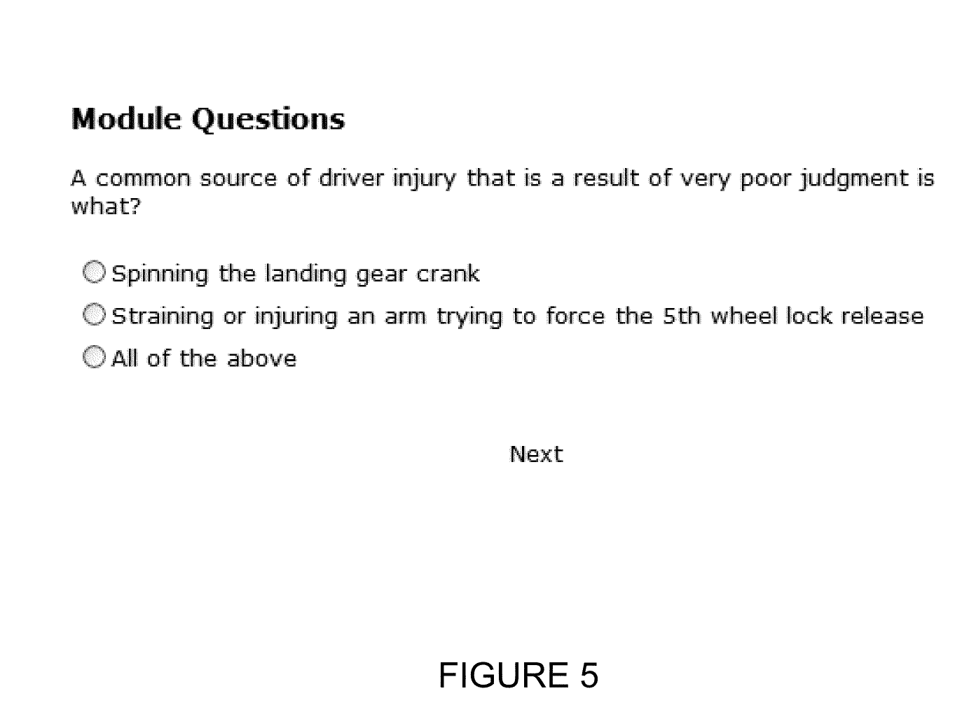

The user then views the training materials (see FIG. 4), and may be tested on the training materials to ensure user retention, comprehension and attendance (see FIG. 5). Testing may occur at various points during the training session, or immediately upon completion. Upon completion, the user may exit the system, or may be presented options for other training modules.

The content can be delivered in a variety of forms: video files; audio files; PowerPoint, PDF files; Word or text files; and the like. Users can choose from among pre-produced videos, or can produce their own. In one embodiment, the system provides instructions to users as to how to produce videos (or other files) for their presentations.

Pre-produced content provided can cover a variety of areas, including, but not limited to, adverse weather, blood borne pathogens, construction and work zones, defensive driving techniques, diet and exercise, distracted drivers, drug and alcohol awareness, road rage, seatbelt use, sexual harassment, speeding, stop signs and signals, tailgating, and transporting passengers.

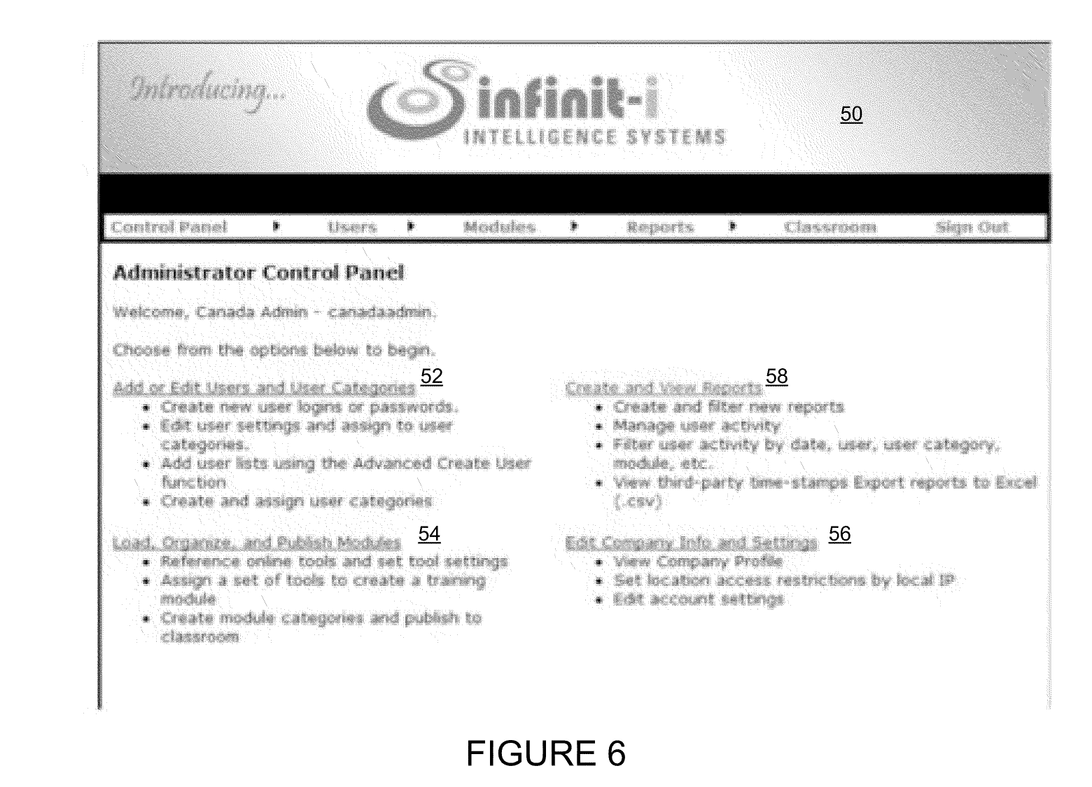

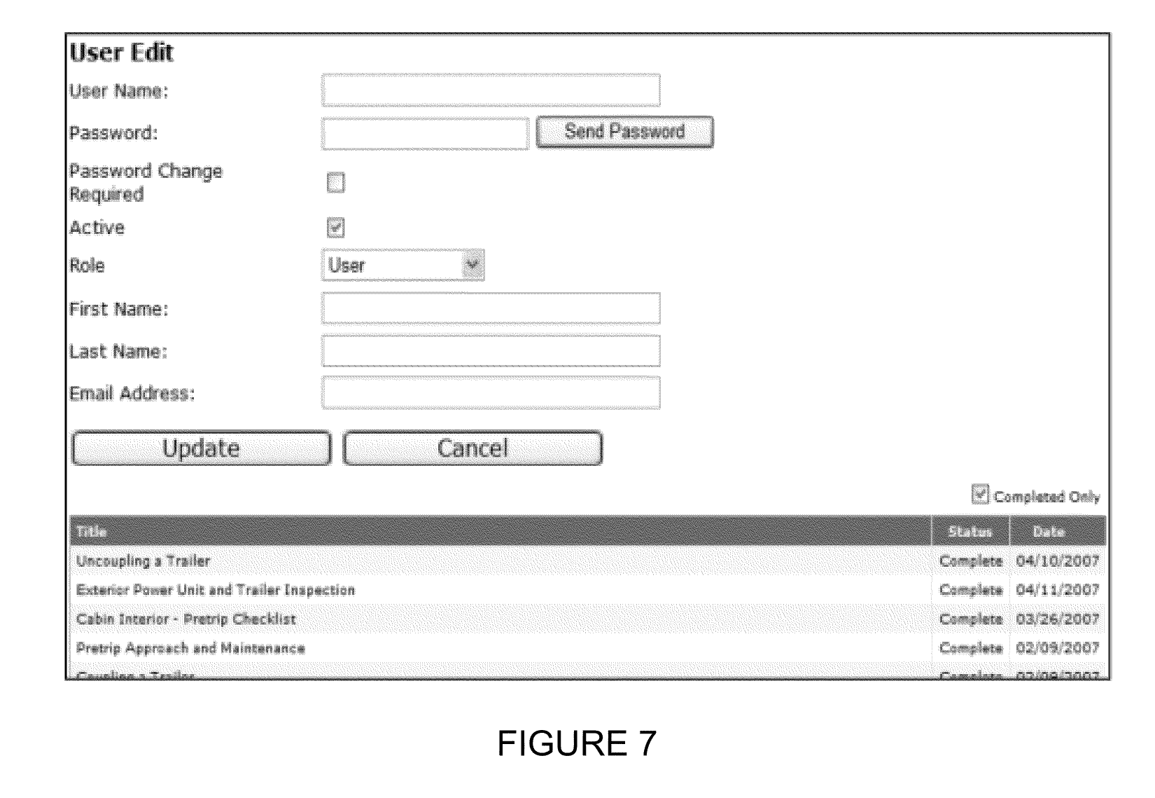

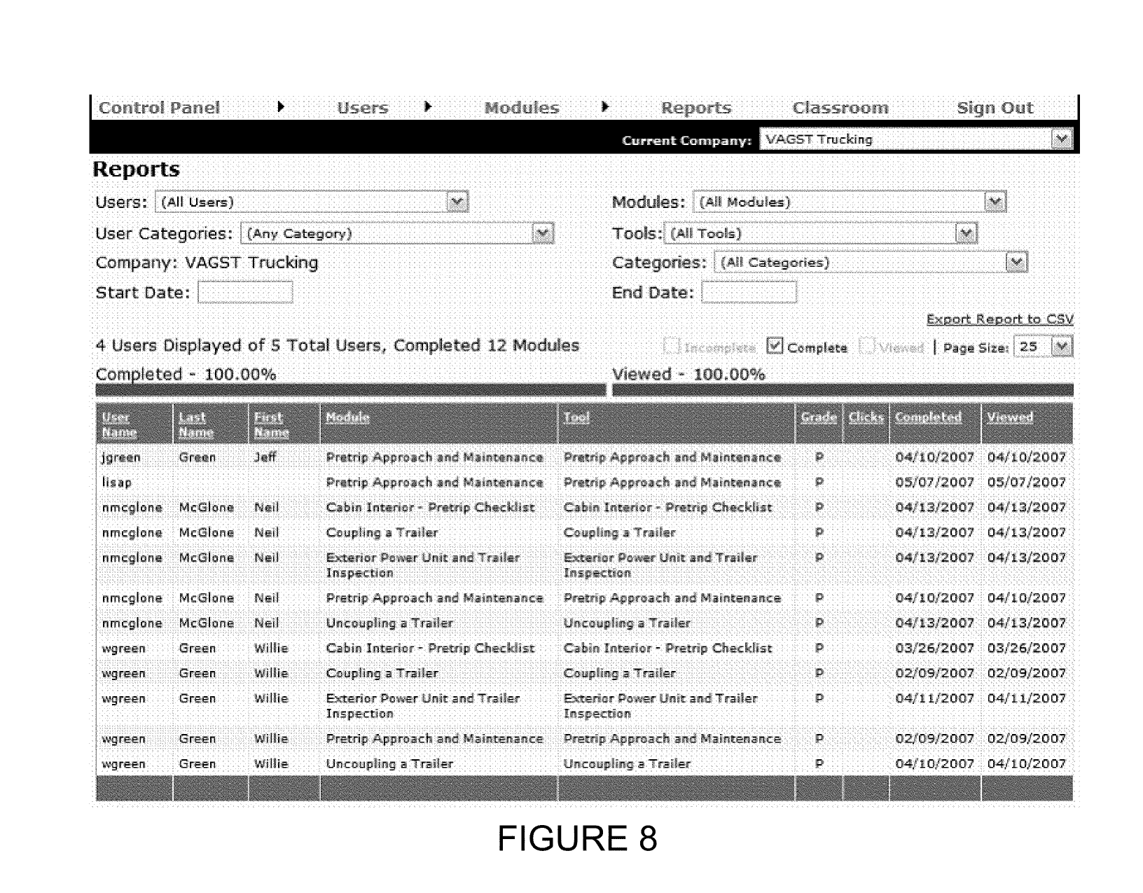

Individuals with administrative rights use the Administrative Control Panel 50 (see FIG. 6) in the Administrative component to accomplish a variety of tasks. Administrators manage users individually or in groups or lists (e.g., add or edit users and user categories) 52, create, load and organize training or communication modules 54, edit company information and settings 56, and generate and view pre-set and customized reports on macro user statistics or specific user details 58, such as date and time-stamped reports of user activity and test results (see FIG. 8). FIG. 7 shows an exemplary embodiment of a page used to add or edit users. The Administrative portal also can be used to generate mass emails to users, deliver user certification certificates, or create third-party records of company training programs.

In various embodiments, there are several levels of access, according to the needs of the user. A “User” may have access only to the classroom and resource center. A “Manager” may have access to the classroom and resource center, can add or edit users (but not a Company Administrator), can run company and activity reports, and can create or edit welcome messages. An “O Deck User” may have access to the classroom and resource center, can record and view observations, and view individual user observation history. A “Company Administrator” may have access to the classroom and resource center, can add or edit users, can create and edit modules, can create or edit welcome messages, can run company, activity and company-wide observation deck reports, can create observation deck modules, and can record and view observations.

In several embodiments, there are certain expectations required of companies participating in the system. Someone within each company must be responsible for identifying opportunities, filming them, crafting slides, compiling modules, and assigning users. In-house “boot camps” may be provided to new administrators or training directors each month (or some other period of time or as needed). These boot camps may be provided at no expense. The camps comprehensively educate personnel not only on the essentials of cinematography and principals of presentation, but specifically how to use the equipment and software to create the modules. They also train these personnel on both how to identify opportunities for improvement within the company as well as how to achieve higher company profits, across all aspects of the organization. Participants engaging in these camps emerge with a complete expertise both as administrators and as ROI capitalization professionals.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A computer-implemented system for employee training, comprising:
a computing device with a microprocessor, said computing device in electronic communication with one or more servers over a network, wherein the microprocessor is programmed to:
provide a training module to at least one user upon request, wherein said training module information resides on the one or more servers; and
test the at least one user upon completion of the training module;
further wherein the system provides one or more reports about results of the testing to individuals other than the user.

2. The system of claim 1, wherein the training module is provided through a web browser.

3. The system of claim 2, wherein the training module is provided through an Internet website customized for a particular company or employer.

4. The system of claim 1, wherein the training module provides training content comprising a video.

5. The system of claim 4, further wherein the training content comprises a PowerPoint presentation.

6. The system of claim 1, further comprising an administrative module.

7. The system of claim 6, wherein said administrative module allows a user to produce training content.

8. The system of claim 6, wherein said administrative module allows a user to add or edit users or user categories.

9. The system of claim 6, wherein said administrative module allows a user to create, load and organize training modules.

10. The system of claim 6, wherein said administrative module allows a user to generate and view reports on user statistics.

11. The system of claim 6, wherein said administrative module allows a user to deliver user certifications.

12. The system of claim 6, wherein said administrative module allows a user to create third-party records of company or employer training programs.

13. The system of claim 1, wherein the training module is a communications module.

14. The system of claim 1, wherein the training module is multi-channel.

15. A non-transitory computer-readable storage medium with an executable program stored thereon, wherein the program instructs a microprocessor to perform the following steps:
providing a training module to at least one user upon request; and
testing the at least one user upon completion of the training module.
